(19) United States
(12) Patent Application Publication
(10) Pub. No.: US 2012/0113694 A1
(43) Pub. Date: May 10, 2012

(54) STEP-DOWN CONVERTER AND INVERTER CIRCUIT

(75) Inventor: Christoph Schill, Ravensburg (DE)

(73) Assignee: DIEHL AKO STIFTUNG & CO. KG, Wangen (DE)

(21) Appl. No.: 13/290,205

(22) Filed: Nov. 7, 2011

(30) Foreign Application Priority Data
Nov. 5, 2010 (DE) 10 2010 050 623.0
Feb. 16, 2011 (DE) 10 2011 011 330.4

(51) Int. Cl. H02M 7/42; H02J 1/10

(52) U.S. Cl. 363/65; 307/151

(57) ABSTRACT

A step-down converter having an improved efficiency has a common input, to which a DC voltage source for applying an input voltage can be connected, and two or more outputs, at each of which a DC voltage can be provided whose value is less than or equal to that of the input voltage. Each of the plurality of outputs is connected to the common input via a positive lead branch and a negative lead branch. At least one inductor is connected in the positive lead and/or the negative lead of each output. At least one switching element is connected in the positive lead and/or the negative lead of each output, such that the outputs of the step-down converter can be operated both in parallel with one another and in series with one another.

### CROSS-REFERENCE TO RELATED APPLICATION

This application claims the priority, under 35 U.S.C. §119, of German patent applications Nos. DE 10 2010 050 623.0, filed Nov. 5, 2010, and DE 10 2011 011 330.4, filed Feb. 16, 2011; the prior applications are herewith incorporated by reference in their entirety.

### BACKGROUND OF THE INVENTION

1. Field of the Invention

The present invention relates to a step-down converter, and to an inverter circuit comprising such a step-down converter.

Step-down converters are very often used in power supplies of a wide variety of types. As in all power electronic assemblies, the aim is to achieve the highest possible efficiency with the lowest possible costs.

An inverter generally requires an intermediate circuit voltage of a specific magnitude in order to generate an AC voltage. An optimum efficiency is usually achieved if the intermediate circuit voltage is precisely matched to the AC voltage to be generated.

Solar generators generally supply a greatly fluctuating DC voltage depending on light incidence, temperature and number of interconnected modules. The wider the range of the DC input voltage which an inverter can process, the more possibilities of appropriate module combinations there are. By way of example, at full load an input voltage range of 1:2 or for full load to no load of 1:2.5 is desirable.

In order to match the solar generator to the inverter, therefore, a step-down converter is often used which steps down the variable DC voltage to a relatively constant intermediate circuit voltage.

FIG. 1 shows the basic form of a conventional step-down converter. The step-down converter has an input and an output. A feeding source 10 supplies a DC voltage that can be tapped off as an input voltage at the input of the step-down converter. This input voltage is reduced by the step-down converter (consisting, in particular, of an inductor 12, a switching element 14 and a diode 16) to a lower output voltage, which is provided at the output 24 of the step-down converter. The capacitors 20 and 22 connected in parallel with the input and output, respectively, of the step-down converter serve for buffering the ripple currents.

The switching element 14 is periodically switched on and off. The duty ratio is chosen by way of a control unit such that a desired output voltage or a desired output current is established. If the switching element 14 is closed, energy flows from the source 10 through the inductor 12 into the load connected to the output 24. Part of the energy is temporarily stored in the inductor 12. If the switching element 14 is open, the current flows via the freewheeling diode 16 and the inductor 12 into the load, the energy previously stored in the inductor 12 being released into the load.

This conventional circuit arrangement has several disadvantages:
High ripple currents occur at the input and output.
A large inductor is required, since large amounts of energy have to be temporarily stored.
The loading of the semiconductors is high.
The efficiency is poor.

Overall, the use of a step-down converter is associated with additional costs, weight and volume. Moreover, the additional losses in the step-down converter reduce the overall efficiency of the inverter circuit.

### SUMMARY OF THE INVENTION

It is accordingly an object of the invention to provide a step-down converter and an associated inverter which overcome the above-mentioned disadvantages of the heretofore-known devices and methods of this general type and which provides for an improved step-down converter having an increased efficiency.

With the foregoing and other objects in view there is provided, in accordance with the invention, a step-down converter, comprising:

a common input for connection to a DC voltage source for supplying an input voltage; and

a plurality of outputs, each configured to carry a DC voltage having a value less than or equal to a value of the input voltage; and

wherein said outputs are connected for operation in parallel with one another and in series with one another.

In other words, the concept of the invention consists in fundamentally altering the topology of the prior-known step-down converter according to FIG. 1 in order to obtain better properties. A DC voltage source, for instance a solar generator, can be connected to the input of the step-down converter according to the invention, said source providing a DC voltage as input voltage of the step-down converter. In contrast with the prior art, the step-down converter according to the invention has two or more outputs, which are preferably operated symmetrically. At each of these outputs a DC voltage can be provided whose value is less than or equal to that of the input voltage.

The outputs can be operated both in parallel and in series with one another. This also includes the possibility of the outputs being operated partly in parallel and partly in series. In addition, it is possible to change rapidly between the different states.

The step-down converter designed in this way has the following advantages, in particular, over the conventional circuit arrangement:
The losses of the step-down converter are significantly lower.
The dependence of the losses of the step-down converter on the input voltage applied e.g. by a solar generator is significantly lower.
The power semiconductors of the circuit arrangement are loaded to a lesser extent.
The components of the circuit arrangement, in particular the inductors, can be configured such that they are smaller (e.g. only approximately half as large).

Overall, a step-down converter having an increased efficiency and improved properties thus arises. The step-down converter according to the invention can be used in a particularly advantageous manner for providing an intermediate circuit voltage for an inverter in a solar installation.

In one advantageous configuration of the invention, each of the plurality of outputs is connected to the common input via a positive lead and a negative lead; at least one inductor is arranged in the positive lead and/or the negative lead of each output; at least one switching element is arranged in the positive lead and/or the negative lead of each output; and the plurality of outputs are connected in series via in each case at least one rectifying element.

By way of example, the outputs can be connected in parallel with the DC voltage source at the input via the inductors by means of the switching elements. Moreover, the outputs can be connected in series with the DC voltage source via said inductors and the rectifying elements.

If the switching elements are permanently switched on, the outputs are statically connected in parallel with the input, i.e. the voltages at the input and at the outputs are identical. By contrast, if the switching elements are permanently switched off, the outputs are connected in series via the rectifying elements and the inductors. Given n outputs, the voltage at the outputs is then the n-th portion of the input voltage if the outputs are operated symmetrically.

Both in the case of static series connection and in the case of static parallel connection of the outputs, no switching losses arise in the step-down converter according to the invention.

In clocked operation, the switching elements are periodically opened and closed. In this case, a wide variety of switching states are conceivable and the switching elements need not necessarily switch synchronously. The voltage at the outputs then lies between the full input voltage and the n-th portion thereof, if symmetrical output voltages are assumed. The duty ratio of the switching elements is regulated by means of a control unit such that the desired voltage or the desired current arises at the input or at the outputs.

In contrast with the conventional step-down converter, both in the case of opened and in the case of closed switching elements, an energy flow from the DC voltage source to the outputs of the step-down converter is possible. As a result, the energy that has to be temporarily stored in the inductors, or the circulating reactive power is significantly smaller. This affords numerous advantages:
The inductors required are significantly smaller.
The loading of the semiconductors is reduced.
The losses are significantly reduced. As a result, the efficiency increases and the cooling is simpler.
The dependence of the step-down converter losses on the voltage of the source is significantly reduced.

By means of suitable dimensioning and positioning of the inductors, which is readily apparent to the person skilled in the art, what can be achieved is that the outputs have a constant potential even in clocked operation, i.e. potential jumps between the input and the outputs and radio interference associated therewith can be substantially avoided.

The switching elements of the step-down converter according to the invention are preferably semiconductor switches. Said semiconductor switches can preferably be operated in clocked fashion or statically.

The switching elements of the step-down converter according to the invention can preferably be clocked with fixed or variable frequency.

The switching elements of the step-down converter according to the invention can preferably be clocked synchronously or asynchronously with respect to one another.

Preferably, a control electronic unit is additionally present, which regulates the current and/or the voltage at the input and/or at the outputs of the step-down converter by varying the clocking of the switching elements.

Antiparallel freewheeling diodes are preferably connected in parallel with the switching elements of the step-down converter according to the invention.

Moreover, measures or means for the currentless and/or voltageless switching of the switching elements are preferably provided.

The rectifying elements of the step-down converter according to the invention are preferably embodied as semiconductor diodes or synchronous rectifiers.

Preferably, buffer capacitors are furthermore connected in parallel with the input and/or with the outputs of the step-down converter.

The inductors of the step-down converter can optionally be separate, partly separate and partly coupled to one another, or completely coupled to one another.

Furthermore, protective measures are preferably provided in order, in the case of a fault, to prevent the plurality of outputs of the step-down converter of the invention from being connected in parallel with the input.

In one advantageous configuration of the invention, two of the switching elements are connected via two further rectifying elements connected in series, wherein a common junction point of these two further rectifying elements is connected to an auxiliary potential. Said auxiliary potential can preferably be provided by means of a tap of the DC voltage source connected to the input or by means of at least one capacitor.

In one advantageous configuration of the invention, two of the inductors are connected in parallel via further rectifying elements respectively connected in series with said inductors.

In one configuration of the invention, the positive pole of the first output is connected at the positive pole of the input, the negative pole of the last output is connected to the negative pole of the input, and all outputs have an approximately constant potential relative to the input.

In a further advantageous configuration of the invention, at least one further switching element is connected in series with the at least one rectifying element. In this case, preferably, in each case at least one further rectifying element is connected in parallel with the outputs, said element making possible a freewheeling of the inductor connected to the respective output.

This configuration of the circuit arrangement advantageously extends the operating range of the step-down converter according to the invention.

Given n outputs, in the symmetrical case, the output voltages can be minimally the n-th portion of the input voltage, since all the outputs are then connected in series with the input via the inductors and the rectifying elements. In order to further reduce the voltage at the outputs, additional switching elements are inserted into the connections between the outputs, e.g. in series with the rectifying elements, said additional switching elements normally being closed. If said additional switching elements are periodically opened, then the individual outputs are periodically isolated from one another, as a result of which the energy inflow from the DC voltage source is periodically interrupted. As a result, the voltage at the outputs decreases further as desired and can be set by means of the duty ratio of the additional switching elements.

As long as the additional switching elements are not completely switched off, energy still flows periodically from the source to the outputs, part of the energy being stored in the inductors. It is necessary to ensure that this energy contained in the inductors can dissipate. For this purpose, the additional rectifying elements are provided, which make possible a freewheeling of the inductors towards those outputs to which they are respectively connected.

In one advantageous development of the invention, the at least one rectifying element and the at least one further rectifying element are embodied as synchronous rectifiers. In a particularly advantageous alternative, the step-down converter can be operated bidirectionally.

The step-down converter of the invention can advantageously be operated in conjunction with energy storage devices, e.g. rechargeable batteries or supercapacitors. In this case, by way of example, an energy storage device connected to the input of the step-down converter can be used as a feeding DC source. However, it is also conceivable to connect energy storage devices to the outputs of the step-down converter, wherein these energy storage devices are charged from a source connected to the input.

If the rectifying elements of the step-down converter are embodied as synchronous rectifiers, it is possible to transmit energy bidirectionally. Consequently, energy storage devices connected to the input or output, for example, can be both charged and discharged. If energy storage devices are connected to the outputs of the step-down converter, then it is possible to operate the energy storage devices asymmetrically by means of asymmetrical driving of the step-down converter. It is thus possible to balance out e.g. asymmetries in their charge state.

In yet another advantageous configuration of the invention, additional switching elements are provided between the positive and negative leads of the outputs in order to be able to connect the plurality of outputs statically in series or in parallel.

Finally, it is also possible for two or more of such step-down converters according to the invention to be operated in parallel or in series. In this case, the step-down converters operated in parallel preferably operate in multiphase operation, wherein it is furthermore preferably possible to switch off individual step-down converters in order to increase the efficiency in the case of partial load.

With the above and other objects in view there is also provided, in accordance with the invention, an inverter circuit, especially an inverter circuit that is provided for a solar generator. The inverter circuit comprises a step-down converter as outlined above and at least one inverter for converting the output voltages provided by the step-down converter at the plurality of outputs into an AC voltage.

In other words, the step-down converters of the invention can advantageously be used in an inverter circuit, more particularly a solar inverter circuit, comprising at least one inverter for converting the output voltages provided by the step-down converter at the plurality of outputs into an AC voltage, in order thus to increase the efficiency of the entire inverter circuit.

In the field of solar inverters it is generally customary to step down the greatly varying voltage of a solar generator by means of a step-down converter to an approximately constant voltage and to operate a connected inverter therewith. The inverter then does not need to be overrated for high input voltages and operates with optimum efficiency.

Although the above-described step-down converter of the invention has a higher efficiency than a conventional step-down converter, it has at least two outputs which, owing to their potential differences, cannot be connected in parallel. Therefore, the known series circuit composed of a step-down converter with a single downstream inverter of conventional type has to be modified.

The structure of the solar inverter is changed according to the invention such that the energy made available at the outputs of the step-down converter separately with different potentials can be combined again and fed into a common power supply system. The extra outlay associated therewith is negligible compared with the gain in efficiency.

One possibility consists in connecting a separate inverter to each output of the step-down converter, wherein the inverters are transformer-coupled to a power supply system (electrical power mains, island network) or load. The potential differences between the step-down converter outputs can be bridged by the transformer coupling. This solution is suitable for example when the power supply system lead into the medium-voltage power supply system is intended to be effected, for which purpose a medium-voltage transformer is required anyway.

A second possibility consists in using one or a plurality of potential-bridging DC/DC converters that feed the energy from the outputs of the step-down converter via a common intermediate circuit and an inverter fed therefrom into the electrical power mains. Alternatively, potential-bridging DC/AC converters are also possible, which lead directly into the electrical power mains. This solution is suitable if potential isolation within the solar inverter is desired anyway.

A further possibility consists in connecting a separate inverter to each of the plurality of outputs of the step-down converter, wherein each of said plurality of inverters provides only a portion of the required AC voltage to a power supply system or a load.

Yet another possibility consists in connecting a common inverter with multiple input to the plurality of outputs of the step-down converter.

Other features which are considered as characteristic for the invention are set forth in the appended claims.

Although the invention is illustrated and described herein as embodied in a step-down converter, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings. The exemplary variants described below can be implemented respectively by themselves or in many cases also in combination with one another.

In the case of such combinations, it is conceivable that, depending on the operating state, e.g. depending on the magnitude of the input or output voltage of the step-down converter, a changeover is made between different variants, e.g. by means of the switching elements of the relevant variant being activated or inactivated. As a result, it is possible e.g. to select in each case the variant or the operating mode which has the best efficiency under the given boundary conditions.

### BRIEF DESCRIPTION OF THE SEVERAL VIEWS OF THE DRAWING

FIG. 1 shows a schematic block diagram illustrating a basic form of a conventional step-down converter according to the prior art;

FIG. 2 shows a schematic block diagram of a first exemplary embodiment of a step-down converter according to the invention;

FIG. 3 shows a schematic block diagram of a second exemplary embodiment of a step-down converter according to the invention;

FIG. 4 shows a schematic block diagram of a third exemplary embodiment of a step-down converter according to the invention;

FIG. 5 shows a schematic block diagram of a variant of the step-down converter from FIG. 2, equipped with additional components for statically bridging components;

FIG. 6 shows a schematic block diagram of a series circuit formed by step-down converters from FIG. 2;

FIG. 7 shows a schematic block diagram of a first variant of an extension of the step-down converter from FIG. 2 to three outputs;

FIG. 8 shows a schematic block diagram of a second variant of an extension of the step-down converter from FIG. 2 to three outputs;

FIG. 9 shows a schematic block diagram of a variant of the step-down converter from FIG. 2 with an additional circuit for extending the operating range;

FIG. 10 shows a schematic block diagram of a first exemplary embodiment of an inverter circuit according to the invention;

FIG. 11 shows a schematic block diagram of a second exemplary embodiment of an inverter circuit according to the invention;

FIG. 12 shows a schematic block diagram of a power supply device according to the invention with an energy storage device; and

FIG. 13 shows a diagram for illustrating the improved efficiency of the step-down converter according to the invention in comparison with the prior art.

### DETAILED DESCRIPTION OF THE INVENTION

Referring now once more to the figures of the drawing in detail, FIG. 2 illustrates a first embodiment of the step-down converter according to the invention. Basic functions of the step-down converter according to the invention and possible configurations in questions of detail will be explained more comprehensively below on the basis of this example.

The feeding source 10 supplies a DC voltage. A wide variety of DC sources are conceivable as the source, such as e.g. solar generators, i.e., banks of PV cells, fuel cells, thermoelectric generators, rechargeable batteries, batteries, redox flow batteries, supercapacitors, electromagnetic generators, AC/DC converters or DC/DC converters.

The DC voltage of the source 10 is reduced by the step-down converter (comprising the switching elements 14a, 14b, the rectifying element 16 and the inductors 12a, 12b) to a lower output voltage, which is provided simultaneously at two outputs 24a, 24b.

The switching elements 14a, 14b can be power semiconductors such as MOSFETs or IGBTs. Freewheeling diodes can be reverse-connected in parallel with the switching elements 14a, 14b internally or externally. Said diodes protect the switching elements 14a, 14b against reverse voltages and make possible a freewheeling if the step-down converter is operated asymmetrically.

In order to reduce the switching losses, ring-around networks and the like can additionally be incorporated, which make it possible to switch the switching elements 14a, 14b at the current and/or voltage zero crossing.

The inductors 12a and 12b can be coupled or separate.

The inductors 12a, 12b can also be located in the respectively opposite lead branch (i.e., lead path) relative to the respective output capacitors 22a, 22b. Moreover, they can in each case be split into two partial inductors of identical or different size, wherein one partial inductor is respectively situated in the positive and one partial inductor is respectively situated in the negative lead branch relative to the respective output capacitor 22a and 22b. The position of the inductors 12a, 12b determines the potential of the outputs 24a, 24b in clocked operation in relation to the source 10.

In order to avoid radio interference, the position of the inductors 12a, 12b is preferably chosen such that the potentials of the outputs 24a, 24b in relation to the source 10 do not jump, but rather are constant. In the case of the circuit in FIG. 2, this means that the inductors 12a, 12b are positioned as depicted. Both outputs are then fixedly connected to the source 10 at a respective pole, as a result of which no potential jumps can occur between the input and the outputs.

In other embodiments of the invention, which are described further below (FIGS. 6, 7, 8), it is necessary in some instances to split inductors in order to avoid potential jumps.

The rectifying element 16 may, for instance, be a semiconductor diode. However, it can also be replaced by an active switching element (synchronous rectifier) in order to increase the efficiency.

The capacitors 20 and 22a, 22b connected in parallel with the input and the outputs 24a, 24b, respectively, serve for buffering the ripple currents.

Loads can be connected to the outputs 24a, 24b. Possible loads include DC voltage power supply systems or assemblies which pass on the energy, e.g. inverters or battery chargers. Both outputs 24a, 24b are preferably fed the same voltage and the same current, that is to say operate symmetrically. However, asymmetrical operation is also conceivable.

Both outputs 24a, 24b are interconnected via the step-down converter in such a way that they are connected in parallel with the source 10 via the inductors 12a, 12b with the switching elements 14a, 14b closed and in series with the source 10 via the rectifying element 16 and the inductors 12a, 12b with the switching elements 14a, 14b open.

If the voltage of the source 10 is 100% of the output voltage, then a static parallel connection of the outputs 24a, 24b suffices to supply the output voltage. No switching losses whatsoever arise in that case.

If the voltage of the source 10 is 200% of the output voltage, then a static series connection of the outputs 24a, 24b suffices to supply the output voltage. No switching losses whatsoever arise in that case either.

If the voltage of the source 10 is between 100% and 200% of the output voltage, then the switching elements 14a, 14b are operated in clocked fashion. The duty ratio is regulated by closed-loop control by way of a control unit (not illustrated) such that the desired voltage or the desired current arises at the outputs 24a, 24b. Control units of this type are known to those of skill in the pertinent art and will be assumed to be known for purposes of this description. It is also possible to closed-loop control with regard to voltage or current at the input. This is often employed e.g. if the DC voltage source used is a solar generator that is intended to be operated at the maximum power point. The duty ratio varies between 0% (static series connection) and 100% (static parallel connection).

Given different duty ratios at the switching elements 14a and 14b, it is possible for the outputs 24a, 24b to be loaded asymmetrically.

Both switching elements 14a, 14b are preferably clocked synchronously. Asynchronous operation is also conceivable. In this case, a coupling of the inductors 12a, 12b is generally unfavourable.

The switching elements 14a, 14b can be driven with fixed or variable frequency. If the voltage of the source 10 is in the vicinity of 100% or 200% of the output voltage, then it is possible e.g. to lower the frequency in order to reduce the switching losses.

Further embodiments of the step-down converter according to the invention are described below, although substantially only their special properties are mentioned. Nevertheless, the previously described detail solutions such as e.g. the replacement of rectifying elements by synchronous rectifiers or the splitting of inductors can, of course, equally be implemented in many cases.

FIG. 3 shows a second embodiment of the step-down converter according to the invention.

In contrast with the circuit in FIG. 2, further rectifying elements 17a, 17b are incorporated, which are connected to a potential preferably lying symmetrically in the middle between the two potentials of the input.

This potential can be generated e.g. via the capacitors 20a, 20b, which are connected in series with one another and in parallel with the input.

It is also conceivable for the source 10 itself to provide said potential, e.g.

in the form of a center tap.

By virtue of this measure, the switching elements 14a, 14b are protected against transient overvoltages. As a result, the dielectric strength of the switching elements 14a, 14b can be reduced to half of the maximum source voltage.

The switching elements 14a, 14b can be clocked synchronously or asynchronously.

The further rectifying elements 17a, 17b can be used as an alternative or in addition to the rectifying element 16. The latter then carries the main current, while the rectifying elements 17a, 17b merely serve as overvoltage protection for the switching elements 14a, 14b.

FIG. 4 shows a third embodiment of the step-down converter according to the invention.

In contrast with the circuit in FIG. 2, further rectifying elements 17c, 17d are incorporated, which make possible a freewheeling of the inductors 12a, 12b directly towards the outputs 24a, 24b, wherein both inductors 12a, 12b can be operated in parallel.

By virtue of this measure, the switching elements 14a, 14b are protected against transient overvoltages. As a result, the dielectric strength of the switching elements 14a, 14b can be reduced to the magnitude of the output voltage.

The switching elements 14a, 14b can be clocked synchronously or asynchronously.

In comparison with the circuits according to FIGS. 2 and 3, some differences arise as a result of the altered linking of the further rectifying elements 17c, 17d:

This circuit variant can afford advantages in the dimensioning of the components and in the efficiency, e.g. if the output powers are constant, but the output voltages are intended to be variable. In this case, the output currents are higher, the lower the output voltages. In the case of low output voltages, however, the outputs 24a, 24b are predominantly connected in series. Both inductors 12a, 12b can be operated in parallel instead of in series in the case of the freewheeling or in the case of series connection of the outputs. As a result, the output current which is increased in the case of small output voltages is shared between the inductors 12a, 12b to an increased extent. It can be shown that, as a result of this contrary effect, the current in the individual inductors 12a, 12b remains approximately constant. Consequently, the maximum current occurring in the inductors 12a, 12b is significantly reduced, as a result of which the structural size of the inductors 12a, 12b can also be reduced. Moreover, the maximum current loading of the switching elements 14a, 14b and of the additional rectifying elements 17c, 17d is also reduced.

During the freewheeling, larger voltages are present at the inductors 12a, 12b, i.e. the inductance of the inductors 12a, 12b should be increased somewhat.

The voltage swings at the switching elements 14a, 14b are generally greater, therefore the losses rise there.

The duty ratio during the driving of the switching elements 14a, 14b is altered somewhat with otherwise identical conditions.

The additional rectifying elements 17c, 17d can be used as an alternative or else in addition to the rectifying element 16. The rectifying element 16 then carries the main current, while the further rectifying elements 17c, 17d merely serve as overvoltage protection for the switching elements 14a, 14b. However, the circuit then again behaves substantially identically to the circuits according to FIG. 2 or 3.

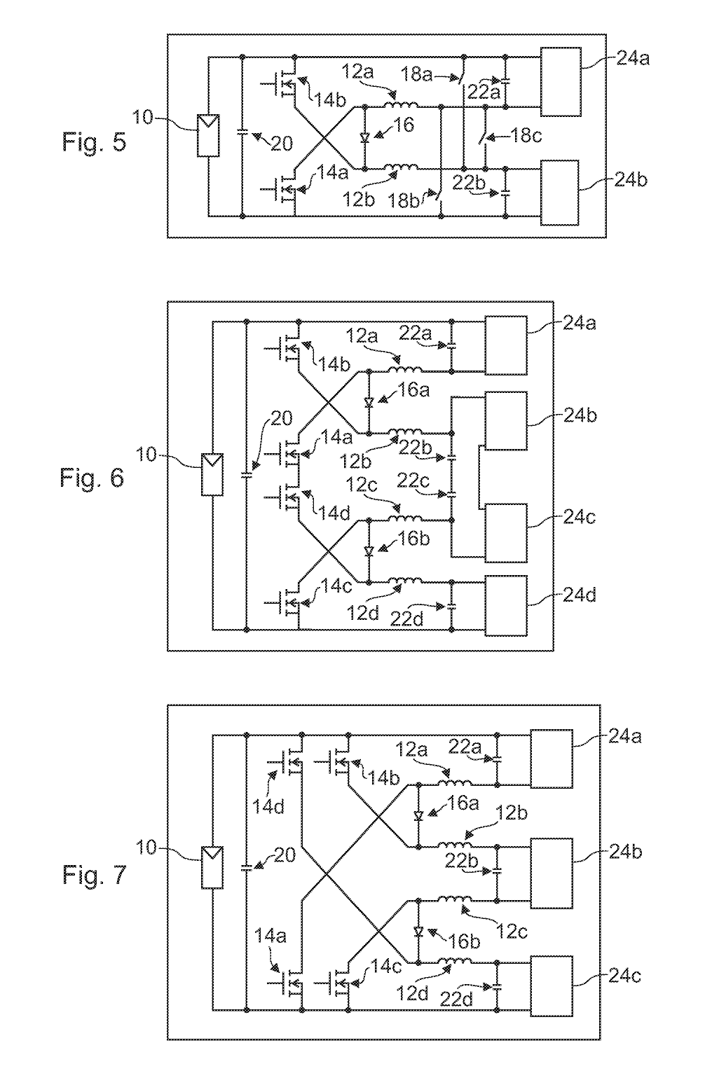

FIG. 5 shows a variant of the first embodiment of the step-down converter according to the invention from FIG. 2, equipped with additional components for statically bridging components.

In the case of static operation (parallel or series connection of the outputs) components can be bridged in order to increase the efficiency. This can be done e.g. with the aid of the further switching elements 18a, 18b, 18c. These can be e.g. relays or semiconductor switches. In the case of component 18c, it is also possible to use a diode, wherein a diode having a very low forward voltage is preferably used.

Parallel connection of step-down converters.

Two or more of the step-down converters according to the invention can be connected in parallel. In this case, the individual step-down converters can be operated in a phase-offset fashion in order to reduce the ripple currents at the input and at the outputs 24a, 24b (multiphase operation). Moreover, in the case of partial load, individual step-down converters can be completely switched off in order to increase the partial load efficiency.

Series connection of step-down converters

FIG. 6 shows the series connection in the first embodiment of the step-down converter according to the invention.

Two or more step-down converters can be connected in series. In this case, it is additionally possible to save components:
The switching elements 14a, 14d can be combined into one.
The buffer capacitors 22b, 22c can be combined into one buffer capacitor.
The inductors 12b, 12c can be combined into one inductor situated at the location of the inductor 12b or 12c. This has the disadvantage, however, that the potential of the outputs 24b, 24c jumps relative to the source 10, which can cause radio interference. It is better, therefore, not to combine the inductors 12b, 12c, but rather to choose them to be of the same size, in order that symmetrical voltage drops occur at both inductors 12b, 12c and the potential of the outputs 24b, 24c remains steady.
The inductors 12a-12d can be separate, partly separate or completely coupled to one another.
The outputs 24b, 24c can be combined.

Extension of the relative input voltage range by extension to more than two sources

The relative input voltage range, which amounts to 1:2 or 100 . . . 200% of the output voltage in the case of the circuits according to FIGS. 2 to 5, can be increased as desired by increasing the number of outputs. For this purpose, the step-down converter according to the invention is extended such that all outputs can be interconnected both in parallel and in series with the DC voltage source 10.

FIG. 7 shows a first variant of an extension of the first embodiment of the step-down converter according to the invention to three inputs.

All three outputs 24a, 24b, 24c are preferably operated symmetrically, that is to say acquire the same output voltage and the same output current.

By switching on the switching elements 14a-14d, it is possible for the outputs 24a-24c to be connected in parallel with the source 10 via the inductors 12a-12d. Moreover, the outputs 24a-24c are connected in series with one another via the rectifying elements 16a, 16b and the inductors 12a-12d.

If the voltage of the source 10 is 100% of the output voltage, then a static parallel connection of the outputs 24a-24c suffices in order to supply the latter with the appropriate output voltage. If the voltage of the source 10 is 300% of the output voltage, then a static series connection of the outputs 24a-24c suffices in order to supply the latter with the appropriate output voltage.

If the voltage of the source 10 is between 100% and 300% of the output voltage, then the switching elements 14a-14d are operated in clocked fashion, preferably synchronously. This results in an extended input voltage range of 1:3 or 100 . . . 300% of the output voltage, which can be advantageous in the case of sources having a greatly varying voltage.

Only one inductor is required for each output 24a-24c. However, it is advantageous to split the inductor for the load 24b, as shown in FIG. 7. What is achieved as a result is that the output 24b as well as the outputs 24a and 24c are at constant potential relative to the DC voltage source 10. Interference emissions can be reduced as a result.

According to this scheme shown, the step-down converter according to the invention can be extended to n outputs, wherein the relative input voltage range is increased to 1:n. The more outputs are present, the greater the relative input voltage range becomes. However, the efficiency decreases.

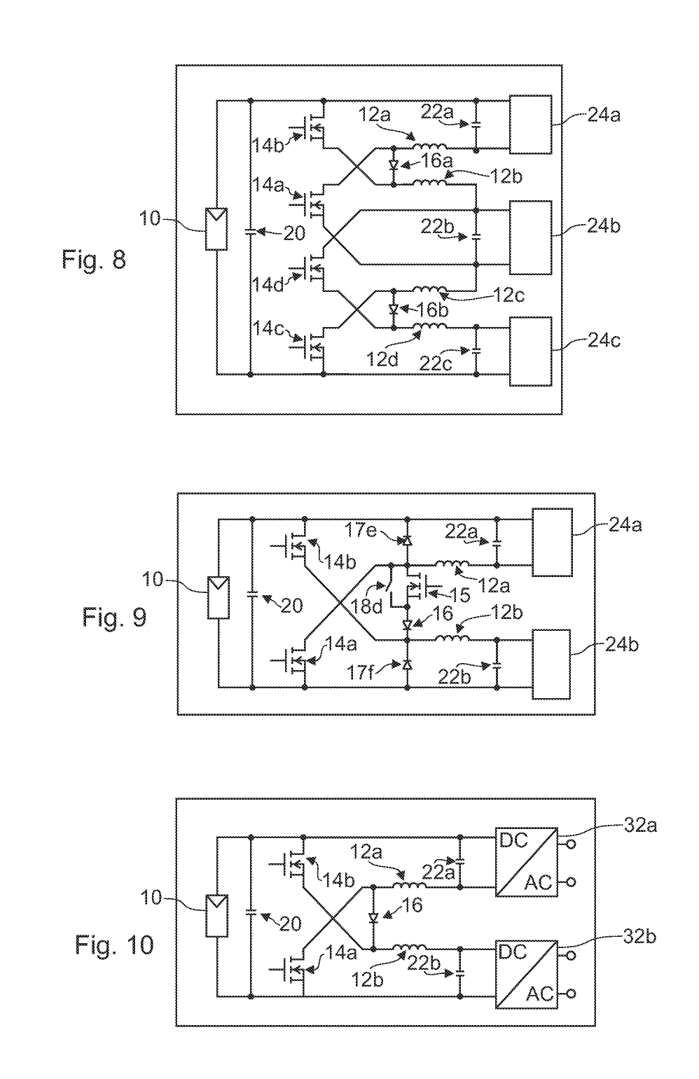

FIG. 8 shows a second variant of an extension of the first embodiment of the step-down converter according to the invention to three inputs.

Alternatively, the switching elements 14a, 14d can also be interconnected towards the middle output 24b instead of directly towards the source 10. The parallel interconnection of the output 24a with the source 10 is then effected via the switching elements 14a, 14c and the inductors 12a, 12c. The same analogously applies to the third output 24c.

Extension of the operating range by an additional circuit

In the absence of loading by loads, it can happen that the source has a very high no-load voltage. This case occurs e.g. with solar generators, primarily with thin-film modules.

In this case it can happen that the division of the input voltage as a result of the static series connection of the outputs does not suffice and the voltage at the outputs is still too high. In order to extend the relative input voltage range or to decrease the minimum output voltage, the number of outputs can be increased, as described above. However, there is yet another method, wherein the number of outputs does not have to be increased.

The step-down converter according to the invention can be extended by additional components that make it possible to reduce the voltage of the source 10 further and even down to zero.

FIG. 9 shows the first embodiment of the step-down converter according to the invention from FIG. 2, combined with an additional circuit for extending the operating range.

The circuit from FIG. 2 is extended by the further rectifying elements 17e, 17f, the further switching element 15 and the bridging element 18d.

The further rectifying elements 17e, 17f are inserted into the circuit present in such a way as to make possible a direct freewheeling of the inductors 12a, 12b to the outputs 24a, 24b respectively connected thereto. The further rectifying elements 17e, 17f can also be replaced by active switching elements (synchronous rectifiers).

The further switching element 15 is preferably a semiconductor switch and can have an antiparallel diode. The bridging element 18d is connected in parallel with the further switching element 15. It can be a relay contact and is not absolutely necessary. It serves for statically bridging the further switching element 15, whereby the forward losses thereof in the static on state are eliminated. The further switching element 15 and the bridging element 18d are incorporated in series with the rectifying element 16 present.

If the voltage of the source 10 is 100 . . . 200% of the output voltage, then the bridging element 18d or the further switching element 15 is closed and the circuit operates like the circuit according to FIG. 2.

If the voltage of the source 10 is greater than 200% of the output voltage, then the switching elements 14a, 14b are permanently switched off. The bridging element 18d is permanently opened. The further switching element 15 is periodically clocked. With the further switching element 15 switched on, the current flows in series through the loads connected to the outputs 24a, 24b, the inductors 12a, 12b, the rectifying element 16 and the further switching element 15.

With the further switching element 15 switched off, the current flows in the inductor 12a via the further rectifying element 17e back to the output 24a. Likewise, the current flows in the inductor 12b via the further rectifying element 17f back to the output 24b (in the manner of a traditional step-down converter).

The lower the duty ratio of the further switching element 15, the greater the extent to which the voltage of the source 10 is reduced. If the duty ratio tends towards zero, then the output voltages also decrease to zero.

By varying the duty ratio of the further switching element 15, e.g. with the aid of a control unit, it is possible to regulate the voltages and/or currents at the input and/or at the outputs 24a, 24b.

The extension circuit shown can likewise be used in an analogous manner for other embodiments of the step-down converter according to the invention, which is readily evident to the person skilled in the art.

In the case of the circuits according to FIGS. 3 and 4, a further switching element 15 has to be connected in series e.g. with each further rectifying element 17a . . . d (and if appropriate 16, if present). Since in these cases, at least two further switching elements 15 are present, these can be clocked asynchronously, whereby asymmetrical operation of the outputs 24a, 24b is made possible. In this case, a coupling of the inductors 12a, 12b is generally unfavourable.

Protective Measures

In the case of a high voltage of the DC voltage source 10, an undesired parallel connection of the outputs 24a . . . d and hence an impermissibly high output voltage can occur in the event of a defect in one or a plurality of switching elements (14a-14d).

In order to prevent this, protective devices can be incorporated, which interrupt or short-circuit current paths in the case of the fault. For this purpose, there are multiple possibilities, e.g.:
Short circuit of the source 10 (primarily in the case of sources having a low short-circuit current such as e.g. solar generators);
Thyristor circuits (“Crowbar” circuits), possibly in conjunction with fuses;
Disconnection of the source 10 by means of semiconductors or relays.

Since relays have low forward losses, they are more suitable than semiconductors. However, they switch slowly and arcs can form at the contacts. In order to counteract that, it is possible to combine relays with semiconductors. By way of example, relays and semiconductors can be connected in parallel. The relay opens first, while the semiconductor is still in the on state. The semiconductor then opens. Arcs at the relay contact are thus prevented. It is also conceivable to short-circuit the source with a semiconductor, then to disconnect the source by means of relays and, finally, to open the semiconductor again, in order to prevent a continuous loading of the source.

The protective measures can also be implemented elsewhere in the circuit rather than at the source.

The step-down converter according to the invention is suitably used for inverters. That is, the step-down converter can be used not only for directly feeding DC loads or DC power supply systems but also for feeding DC voltage intermediate circuits in other devices such as e.g. inverters.

An inverter generally needs an intermediate circuit voltage of a specific magnitude in order to generate an AC voltage. An optimum efficiency is achieved if the intermediate circuit voltage is precisely matched to the AC voltage to be generated.

Inverters are often used for solar power supply. Solar generators supply a greatly fluctuating DC voltage depending on light incidence, temperature and number of interconnected modules. The wider the range of the DC input voltage which an inverter can process, the more possibilities the fitter has for finding appropriate solar module combinations. An input voltage range of 1:2 at full load (or 1:2.5 from full load to no load) is desirable.

In order to match the solar generator to the inverter, therefore, a step-down converter is used in some cases. Said step-down converter can step down the varying DC voltage of the solar generator to an approximately constant intermediate circuit voltage. It is also possible to modulate the intermediate circuit voltage with a superposed AC component, which can be advantageous for the optimum matching of the inverter.

Since higher system voltages are to be expected in the future for solar generators, the field of use of step-down converters will presumably expand.

The step-down converter according to the invention has, by comparison with the prior art, a significantly higher and more constant efficiency in conjunction with reduced volume, weight and costs. Moreover, it is possible to keep the potentials at its input constant relative to the outputs by means of the inductors in the step-down converter, as mentioned, being appropriately positioned and dimensioned. This is advantageous because the potential of a solar generator should have no high frequency jumps, for reasons of electromagnetic compatibility.

Various inverter topologies can be used in conjunction with the step-down converter according to the invention. Both single-phase and polyphase inverters can be used. It is possible to use inverters for feeding island networks or for feeding into an electrical power mains.

The step-down converter according to the invention can be used for implementing maximum power point tracking of the solar generator. If the voltage of the solar generator is very high, the step-down converter can be switched to static series connection of the outputs. The voltage of the solar generator is then divided by means of the series connection of the outputs and forwarded without being regulated to the downstream circuit. In this case, the latter can perform the tracking.

The step-down converter according to the invention has at least two outputs, however, which, owing to their potential differences, cannot be directly connected in parallel and fed to a common inverter. Consequently, the known series circuit formed by a step-down converter and a single downstream inverter of a conventional type cannot be employed.

Therefore, the structure of the solar inverter is changed according to the invention such that the energy made available at the outputs of the step-down converter separately with different potentials can be combined again and fed into a common power supply system. The extra outlay associated therewith is negligible compared with the gain in efficiency if—as shown hereinafter—specific boundary conditions are provided.

FIG. 10 shows an inverter arrangement according to the invention in a first embodiment.

In the inverter arrangement according to FIG. 10, two separate inverters 32a, 32b are fed by the outputs of a step-down converter according to FIG. 2. Said inverters can feed into the electrical power mains via in each case a separate or a common transformer. The potential differences between the step-down converter outputs can be bridged by the transformer coupling.

It is possible for the inverters to feed into different phases.

If a step-down converter having three outputs is used, then three inverters can be connected. A three-phase feed is thereby possible.

This solution is suitable, for example, if the power supply system feed into the medium-voltage power supply system is intended to be effected, for which purpose a medium-voltage transformer is required anyway.

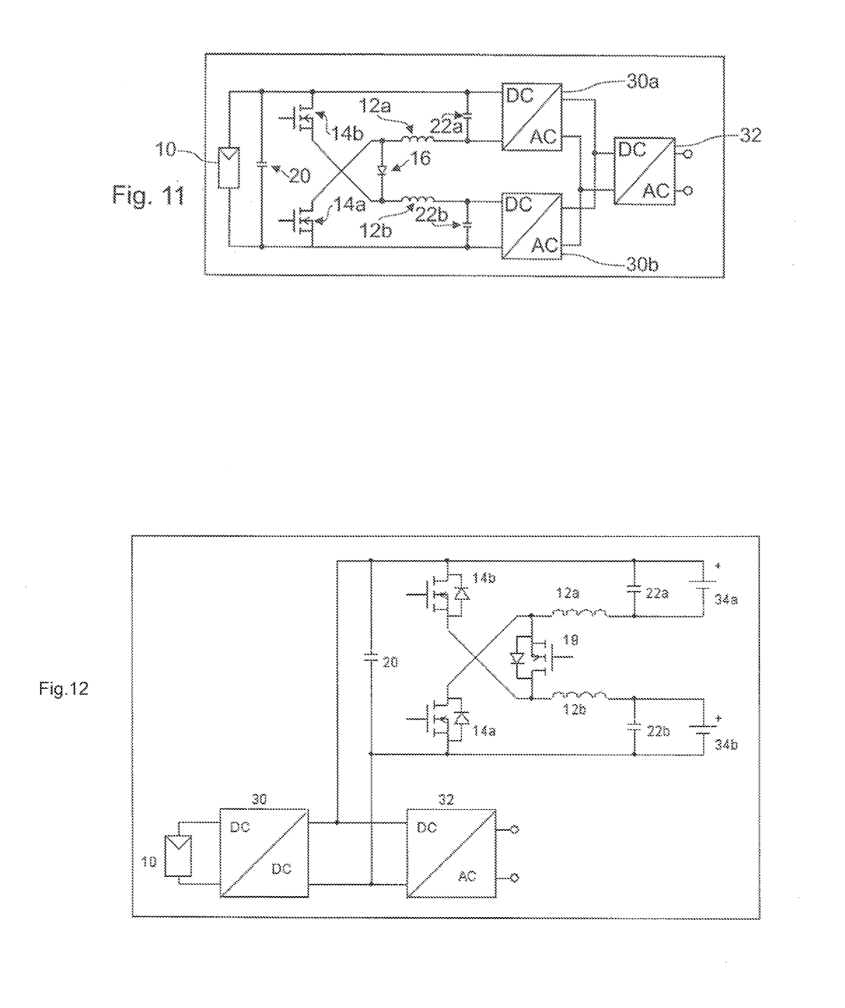

FIG. 11 shows an inverter arrangement according to the invention in a second embodiment:

In the inverter arrangement according to FIG. 11, two separate DC/DC converters 30a, 30b are fed by the outputs 24a, 24b of a step-down converter according to FIG. 2, said converters feeding an inverter 32 via a common intermediate circuit. The different potentials at the outputs 24a, 24b can be bridged with the aid of the DC/DC converters 30a, 30b.

Instead of separate DC/DC converters 30a, 30b, it is also possible to use a common DC/DC converter with multiple input.

This solution is suitable if potential isolation within the solar inverter is desired anyway.

In a third embodiment of the inverter arrangement according to the invention, the inverter used is a potential-bridging DC/AC converter with multiple input, wherein the inputs thereof are connected to the outputs of a step-down converter according to the invention. Such a converter can be constructed e.g. from a flyback converter having a plurality of inputs and a downstream pole-reversing circuit.

This solution is likewise suitable if potential isolation within the solar inverter is desired anyway.

In a fourth embodiment of the inverter arrangement according to the invention, a respective potential-bridging DC/AC converter is connected to two outputs of a step-down converter according to the invention, wherein each of said DC/AC converters generates only in each case one (positive or negative) half-cycle of the power supply system current. In the interconnection of both DC/AC converters, a complete sine wave then arises, which can be fed into an AC power supply system.

This solution is likewise suitable if potential isolation within the solar inverter is desired anyway.

FIG. 12 shows an application in which the step-down converter can be operated in conjunction with energy storage devices.

An inverter 32 converts the energy supplied by a solar generator 10 into AC voltage. In order to match the voltage of the solar generator 10 to the inverter 32, a DC/DC converter 30 can be interposed, which provides an intermediate circuit voltage suitable for the inverter 32 at its output.

It is often desired to buffer-store excess solar energy and to retrieve it again at a later point in time. By way of example, rechargeable batteries or supercapacitors are used for energy storage. These have to be coupled to the rest of the system in such a way that they can be charged and discharged in a controlled manner. Converters are often used for this purpose.

Since the energy passes through the converter both during charging and during discharging of the energy storage device, the losses of the converter become apparent twice in the overall energy balance. Therefore, it is important to use a converter having the highest possible efficiency.

In order to couple the energy storage device to the power supply system, therefore, a step-down converter according to the invention is used in FIG. 12, wherein the circuit variant analogous to FIG. 2 is shown by way of example. In this case, a synchronous rectifier 19 was used as rectifying elements 16. The switching elements 14a and 14b contain antiparallel freewheeling diodes. Consequently, the step-down converter can be operated bidirectionally in order not only to charge but also to discharge the energy storage device.

In this case, the energy storage device consists of two, preferably identical, rechargeable batteries 34a, 34b, which are connected to the outputs of the step-down converter. The coupling to the power supply system is preferably effected via the intermediate circuit of the inverter 32, since the voltage thereof is generally relative constant. Consequently, energy can be drawn from the intermediate circuit and stored in the rechargeable batteries 34a, 34b, e.g. in the case of high irradiation. Conversely, energy can be transmitted from the rechargeable batteries 34a, 34b into the intermediate circuit or into the power supply system, e.g. in the absence of irradiation. If the inverter 32 is able to operate bidirectionally, then it is also possible to buffer-store excess energy from the power supply system.

Asymmetrical driving of the switching elements 14a, 14b makes it possible to operate the rechargeable batteries 34a, 34b asymmetrically, in order e.g. to balance out asymmetries in the charge state thereof.

If a step-down converter according to FIG. 3 is used, and if the inverter has an intermediate circuit with a center-point tap, then both center points can be connected to one another. In this case, it is possible, for example, to compensate for asymmetries between the positive and the negative part of the intermediate circuit or between the two rechargeable batteries 34a, 34b by means of the inverter and/or by means of the step-down converter.

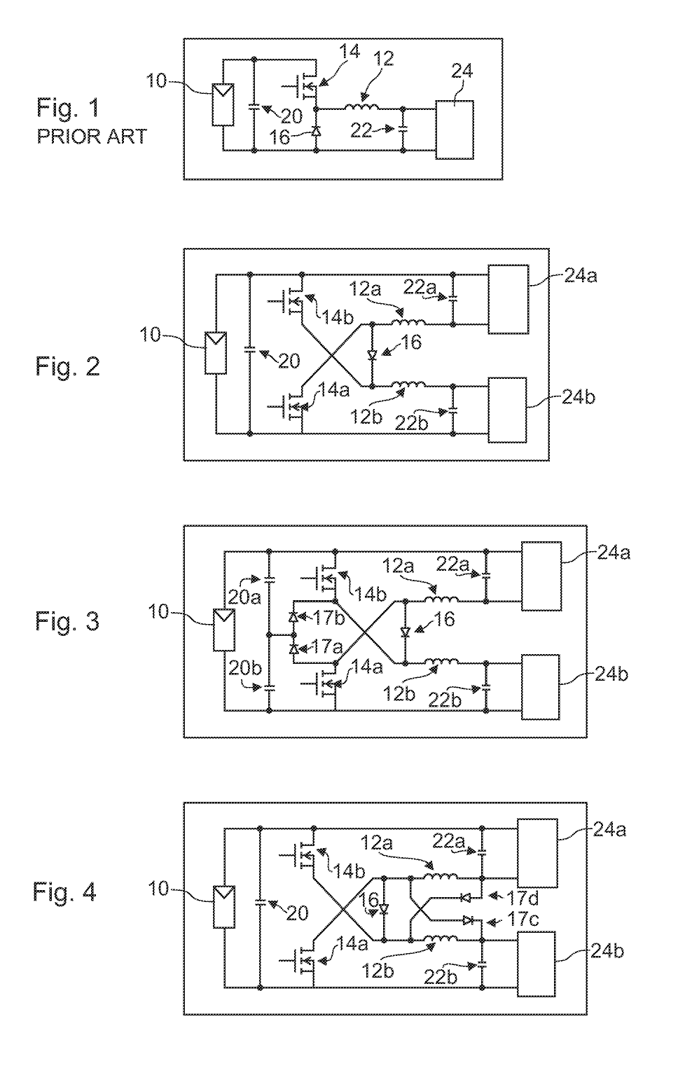

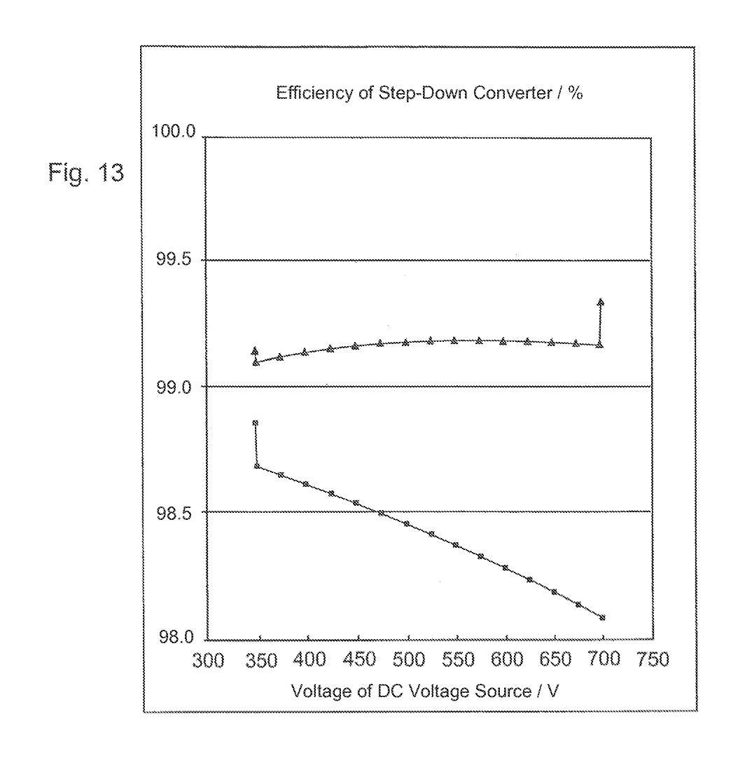

FIG. 13 shows the calculated efficiency profile of the step-down converter according to the invention, as shown in FIG. 2, as a function of the source voltage (upper curve). For comparison therewith, the lower curve shows the efficiency of a step-down converter according to FIG. 1 or the prior art.

In the calculation, an output voltage of in each case 350 V, a constant input power and operation with a constant clock frequency were taken as a basis.

Given a source voltage of 350 V, the two step-down converters do not undergo clocking, as a result of which the switching losses are omitted and the efficiency is correspondingly increased.

In the case of the step-down converter according to FIG. 2, this is also possible in the case of a source voltage of 700 V, as a result of the static series connection of the two outputs.

1. A step-down converter, comprising:
a common input for connection to a DC voltage source for supplying an input voltage; and
a plurality of outputs, each configured to carry a DC voltage having a value less than or equal to a value of the input voltage; and
wherein said outputs are connected for operation in parallel with one another and in series with one another.

2. The step-down converter according to claim 1, wherein:
each of said plurality of outputs is connected to said common input via a positive lead branch and a negative lead branch; and
at least one inductor is connected in one or both of said positive lead branch and said negative lead branch of each output.

3. The step-down converter according to claim 1, wherein:
each of said plurality of outputs is connected to said common input via a positive lead branch and a negative lead branch; and
at least one switching element is connected in one or both of said positive lead branch and said negative lead branch of each output.

4. The step-down converter according to claim 1, which comprises a plurality of rectifying elements disposed to connect said plurality of outputs in series via at least one of said rectifying elements.

5. The step-down converter according to claim 3, wherein two of said switching elements are connected via two further rectifying elements connected in series, wherein a common node of said two further rectifying elements is connected to an auxiliary potential.

6. The step-down converter according to claim 2, wherein two of said inductors are connected in parallel via rectifying elements respectively connected in series with said inductors.

7. The step-down converter according to claim 4, which comprises a plurality of rectifying elements disposed to connect said plurality of outputs in series via at least one of said rectifying elements and wherein at least one further switching element is connected in series with said at least one rectifying element.

8. The step-down converter according to claim 7, wherein in each case at least one further rectifying element is connected in parallel with said outputs, said rectifying element making possible a freewheeling of the inductor connected to the respective said output.

9. The step-down converter according to claim 4, which comprises a plurality of rectifying elements disposed to connect said plurality of outputs in series via at least one of said rectifying elements and wherein said at least one rectifying element and said at least one further rectifying element are synchronous rectifiers.

10. The step-down converter according to claim 9 configured to be operated bidirectionally.

11. The step-down converter according to claim 1, which comprises additional switching elements connected between said positive and negative leads of said outputs, enabling connection of said plurality of outputs statically in series or in parallel.

12. An inverter circuit, comprising:
a step-down converter according to claim 1; and
at least one inverter for converting the output voltages provided by said step-down converter at the plurality of outputs into an AC voltage.

13. The inverter circuit according to claim 12, configured as an inverter circuit for a solar generator.

14. The inverter circuit according to claim 12, wherein:
said at least one inverter is one of a plurality of separate inverters each connected to a respective one of the plurality of outputs of said step-down converter; and
said plurality of inverters are transformer-coupled to a power supply system or a load.

15. The inverter circuit according to claim 12, wherein:
said at least one inverter is one of a plurality of separate inverters each connected to a respective one of the plurality of outputs of said step-down converter; and
each of said plurality of inverters provides only a portion of a required AC voltage to a power supply system or a load.

16. The inverter circuit according to claim 12, wherein said at least one inverter is a common inverter with multiple inputs connected to said plurality of outputs of said step-down converter.

17. The inverter circuit according to claim 12, which comprises a separate DC/DC converter connected to each of said plurality of outputs of said step-down converter, said plurality of DC/DC converters feeding said at least one inverter.
